(19) United States
(12) Patent Application Publication
(10) Pub. No.: US 2015/0363814 A1
(43) Pub. Date: Dec. 17, 2015

(54) System and method for financial card with integrated offer receipt and reward acceptance associated therewith

(71) Applicant: William Hernandez, Stamford, CT (US)

(72) Inventor: William Hernandez, Stamford, CT (US)

(21) Appl. No.: 14/120,683

(22) Filed: Jun. 16, 2014

(51) Int. Cl. G06Q 30/02; G06Q 50/00; G06Q 20/34

(52) U.S. Cl. CPC G06Q 30/0226; G06Q 30/0234; G06Q 20/343; G06Q 50/01

(57) ABSTRACT

A method and system for generating and providing a pre-paid, debit or credit card or other financial instrument card with integrated and associated financial offer receipt, merchant-funded offer, rewards, incentives for consumers to do certain activities for a merchant or manufacturer such as follow them on social media channels and reward acceptance aggregation capabilities associated therewith. The pre-paid, debit or credit card or other financial instrument card may be provided with a financial offer, discount or other benefit in relation to a particular purchase or a general offer, discount or other benefit from a merchant or merchants and may be employed to effectuate the purchase and accept both the benefit of the financial offer or discount and further accept and aggregate additional rewards. The incentive or benefit may also be for an action that they conduct or as an incentive to follow social media or other social interactive forums, gaming type rewards, gaming to win rewards; and additional offers or offer upgrades as they spend at merchants or elsewhere.

### FIELD OF THE INVENTION

The present invention relates to the field of generating and providing a pre-paid, debit or credit card or other financial instrument card with integrated financial offer receipt and reward acceptance aggregation capabilities associated therewith. The pre-paid, debit or credit card or other financial instrument card may be provided with a financial offer, discount or other benefit in relation to a particular purchase or a general offer, discount, incentive, rewards, or benefit. It may also be associated with a benefit to the card holder for an action that they conduct or a credit or incentive to follow social media or other form of social networking (also collectively referred to hereafter as “rewards”) from a merchant or merchants and may be employed to effectuate the purchase and to accept both the benefit of the reward and further accept and aggregate additional rewards. The incentives may also relate to gaming type rewards, gaming to win rewards and additional offers or offer upgrades as cardholders spend at merchants or elsewhere.

More particularly, the present invention further relates to systems and methods for providing pre-paid, debit or credit card or other financial instrument cards to consumers, including a multi-party agreements between one or more merchants offering a financial or other offer or discount, a financial institution supplying the pre-paid, debit or credit card or other financial instrument cards and a processing entity to disseminate and process the financial or other offer or discount to permit one or more merchants to effectuate the associated reward. The incentive may also be associated with an action that they conduct or a credit or incentive to follow social media or other form of social networking or an additional a benefit to the card holder for participation in some activity or agreeing to engage in some action, which is not necessarily related to an actual purchase but may relate to following someone or some entity on social media.

### BACKGROUND OF THE INVENTION

The invention is related to a pre-paid, debit or credit card or other financial instrument card system and in particular to the implementation of a pre-paid, debit or credit card or other financial instrument card system including the creation and usage of a financial card and providing, through financial, institutions or at merchants or other locations financial cards in any amounts the consumer may require and request. For purposes of this invention and specification, the term “financial card” will include and comprise any and all of the various types and iterations of pre-paid, debit or credit cards, including loyalty and other forms of cards and is to be construed in the broadest context, consistent with the scope and disclosure of this invention.

The invention is also related to a financial card system and in particular to the implementation of a financial card system including the creation and usage of a financial card and providing, through financial institutions or other issuing entities pre-paid financial cards in amounts that may be related to fixed monetary sums such as monthly Social Security payments, unemployment benefits, child, care support program, jail programs, food assistance programs and the like.

Numerous types of consumer credit cards, debit cards, pre-paid cards and other forms of financial cards are already in general use. There are: (a) bankcards issued by a bank or other financial institution typical examples of which are MasterCard®, and Visa® cards; (b) a charge card such as issued by American Express® in a series; and (c) the private label cards issued by merchants like Macy's®, Best Buy®, the Home Depot® and so on. Some are issued and serviced by the merchants and some are issued and serviced by financial institutions.

The bankcards allow users to purchase goods and services and charges can be paid off monthly or have a portion paid monthly with remaining balance subject to interest. Some financial institutions may charge annual fees. There are different levels of these cards ranging from a standard card, to a Gold Card or Platinum Card with different annual charges and services. The credit provider sets a dollar amount limit depending on the credit worthiness of the cardholder. The merchant pays an interchange fee based on a percentage of the amount of the individual charge.

The charge card is a card such as the American Express® series of cards. They allow the user to charge purchases and services to the account. The charge balance is expected to be paid in full monthly. There is therefore no interest charged. The purchase limit on such a card is usually not geared to any amount but based on the user's usage history. The cardholder pays an annual fee and the merchant also pays a fee similar to the interchange fee based on the level of purchases.

The private label, card is issued and serviced by and on behalf of a merchant such as Best Buy®, Macy's® and the Home Depot by a financial institution. Some of these private label merchants also issue and service their own cards. The transaction works very similar to a bankcard. The usage is usually limited to the merchant issuing the credit card. The user pays monthly charges or interest on the unpaid balance as with the bankcard. The merchant pays the financial institute a fee similar to the interchange fee paid for a bankcard, though lower. The cards issued by private label merchants usually pay a higher interest rate than holders of bankcards. Merchants prefer not to pay the higher interchange fees associated generally with available bankcards or the American Express® card.

There are also pre-paid financial cards that do not offer the ability of the user to obtain credit for a transaction, but rather permit the user to pay with their own funds that have been associated with and “loaded” on to the pre-paid financial card. That affords the consumers a chance to avoid high credit card interest, being limited in their “credit” line by the amount of the funds loaded on to the pre-paid card and the merchants are assured of hassle-free payments because pre-paid financial cards have the same value as instant cash. The pre-paid financial card also affords the user a unique opportunity of having access to a financial card without having his or her credit history or the lack of it stand in the way. The user puts up his or her money and therefore is not subject to lenders' rules and regulations.

Commercial businesses are constantly looking for new ways to retain and/or increase client base. Product marketing rebates and rewards are well-known to most consumers and have been used by manufacturers and merchants as a tool for promoting and selling products by providing customers with an incentive to purchase particular products, sometimes during a specific period.

Typically, in a rebate or reward system, a consumer will purchase a product and subsequently submit a claim for a benefit or reward associated with that product along with identifying information, such as the consumer's name, address, telephone number, e-mail address, etc. This criteria typically includes filling out a specific form with the name and address of the consumer, enclosing a cash register receipt showing where and when the item was purchased, and sometimes enclosing the Universal Product Code (UPC) or other designated portion of the product packaging to show that the product was actually consumed.

On receipt of the claim and consumer identifying information, the manufacturer, or an agent of the manufacturer, such as a processing center, will transfer the value of the reward or benefit to the consumer. Thus, the consumer is provided with an incentive to purchase products having such reward offers. However, the use of such processing centers is cumbersome and delays the gratification that a consumer enjoys. Moreover, it has been shown that up to 90% of consumers fail to submit the reward information to the processing center, thus providing a boon to the manufacturer and a potential backlash by the consumer who feels that they did not get what they had hope for—the reward or benefit.

In other instances, merchants have been providing localized or hyper local rewards and benefits where a consumer comes in with a physical incentive or an electronic incentive on a mobile device. However, that has the limitation of requiring point of sale involvement to process the incentive and provide the benefit. It has the further limitation of requiring the consumer to have the incentive or reward at the time of the purchase of the related product. Failure to have the incentive will result in the consumer not being able to take advantage of the benefit.

In a further limitation, where such physical incentives are obtained via the Internet and printed, there is the very real possibility of fraud by the multiple use of the the first promotions run by the Gap® in conjunction with Groupon.com® where an incentive was purchased to obtain pants at a substantial discount, the incentive was printed and then the same incentive was redeemed multiple times. The promotion resulted in a $20,000,000 loss to the Gap® during the first two weeks that it was run.

Recently, commercial businesses have offered rebates or rewards in the form of financial loyalty cards. In such methods, consumers submit a reward claim as before. However, rather than receiving a check, the consumers receive a financial loyalty card for the amount of the reward that the consumer may use at the commercial business that offered the initial reward. A drawback of this prior art financial loyalty card system is that a consumer must generally use the financial card at a commercial business that is specified for them.

Also, if several retailers were to issue financial reward loyalty cards, the consumer's wallet or pocketbook would soon be bulging with such loyalty cards for every retailer they patronize, e.g., drug store, grocery store, electronics store, office supply store, toy store, department store, restaurant, etc. Thus, in many instances, the consumer is worse off with a financial reward loyalty card than with a simple check. Additionally, there is some financial burden on the retailer that is inherent in the administration of a loyalty card system. Similarly, the commercial business that initially offers a reward or incentive will not likely want to financially support a financial reward card program wherein the consumer can use the financial reward at any location the consumer desires, such as any location that accepts payment by credit.

Therefore, there is a need for a system and method for providing rewards, benefits, credit and other forms of both monetary and non-monetary incentives to consumers that are tied to or associated with pre-paid financial cards that are easy for consumers to use and provide a financial card solution for incentive and reward offers. The incentives may also be for social media responses and the taking of other non-commercial action at the behest of the person providing the offer. One solution is to have a multi-party agreement between a merchant or merchants (or a manufacturer) offering an incentive or reward, a processing center, and a financial institution supplying financial cards that are capable of having associated with them (loaded on) both general and specific incentives and rewards, including credit for taking non-commercial action such as following someone on social media, while permitting the financial cards to be additionally loaded with funds, in accordance with the dictates of the consumer. Such a system creates benefits for each party involved while opening up an entirely new group of potential consumers to merchants and manufacturers.

There is also a need for a system and method for providing financial cards that provides benefits to consumers, financial institutions, processing centers, and merchants. There is further a need in the art for providing financial cards that are not limited to a single use, such that multiple rewards and incentive can be provided to the consumer using a single financial card.

The field of the disclosure relates generally to the payment card industry, and more specifically, to methods and systems relating to, universal activation, deactivation, and funding of financial cards including reloadable, stored value, prepaid, credit or debit cards and the associated access to such card accounts, for example, via either unrestricted or restricted authorization networks.

The current configuration of the payment card industry includes both open loop and closed loop networks. Specifically, open and closed loop networks have been built on local, regional, national and international scales. For example, banking systems communicate via open loop networks that typically utilize standardized architectures and protocols, such as International Organization for Standardization (ISO) standard 8583, to ensure interoperability worldwide from retailer, to bank card networks, to bank card processors.

As was discussed earlier, examples of open loop bank card networks include Visa®, MasterCard®, American Express®, and Discover®. Services offered by these companies include credit, debit, prepaid, and other reloadable card services as well as other varieties of financial cards. Further examples of similar open loop networks include network associated with banking, for example, Cirrus®, Plus®, Starcard®, and Interlink® signature and pin-based debit card networks. The scope of the worldwide open loop, payment network includes over 20 million points of sale/points of payment, i.e., POS/POP, or merely POS.

Closed loop networks typically communicate via proprietary architectures and protocols directly between POS systems at retailers and switching platforms where databases associated with the various card accounts reside. Such closed loop network systems are developed using proprietary protocols and processing architectures. Therefore, gateway switches are needed to complete protocol mapping and translation between the various proprietary systems. Closed loop networks may operate from tens to a few hundred thousand points of payment or service. Examples of such closed loop networks include retail card programs such as Apple iTunes®, Starbucks®, Facebook®, and Target® cards.

Hybrid networks have been created that utilize a discrete subset of an international open loop bank card network to emulate the features of the proprietary closed loop network. These hybrids are often referred to as restricted authorization network(s) or RAN(s). A RAN typically is built around a common loyalty, geographic, or business theme that provides a natural and often obvious relationship for the network to operate. An example would be a card for a particular mall, and usable with at least a majority of the retailers associated with the particular mall.

Retail and service oriented companies have created proprietary, closed loop, processing platforms where transactional gateways and bridges to open loop networks are typically implemented and segmented separately from the internal POS systems. Transactional routing and custom logic supporting message translation is used within a gateway switch to link internal POS networks to the open loop networks. Both closed loop processing platforms and open loop processing platforms may include virtual Internet, mobile sites, and electronic wallets where a plurality of funded prepaid accounts reside within their domain of operation.

In certain applications, a physical format of prepaid cards typically is proprietary to the networks for which the card has been assigned. Some cards utilize only a barcode while others utilize a magnetic strip (or stripe). In Europe and increasingly in the United States, chip EMV have been incorporated into financial cards. Still others may incorporate both or still further the well known 16-digit card number may be printed (or imprinted) on such cards. In summary, card structures vary between open and closed loop networks. One specific format is utilized for payment cards intended for use in the open loop networks that allows such cards to traverse the entire 20 million points of the worldwide open loop network. Alternatively, proprietary closed loop cards are limited to a single network and the finite number of locations available to the card issuer and processor.

In regard to card activation services for both the open loop and closed loop network, activation networks currently exist in the form of direct connections to retail POS/POP systems. Such connections may be via Web based or direct connect client/server architectures, via mobile applications and gateways, as features of the merchant acquirer networks and services, as applications that reside within POS systems, and as features of the global, universal payment networks such as VISA®, MasterCard®, Discover®, and American Express®. The majority of stored value, prepaid card accounts are activated via closed loop, retail issuers. Other closed loop payment card activations are via gift card mall services offered by various entities and many others as well as via web-based applications. Industry examples of companies offering and managing activation and funding networks include inComm®, Blackhawk Network, Green Dot®, NetSpend^{SM}, and PayPal®.

Growth in retail and service industry credit card programs in the United States has reached a plateau, with minimal year over year growth, although that trend may be shifting now that the current recession appears to be on the wane and consumers are starting to spend and accumulate credit. The industry is researching opportunities to leverage marketing and service partner relationships to offer new stored value, products and services. One of the problems and issues with current stored value products and the processes used to activate, deactivate, load, and reload cards and virtual accounts is that activation and funding of a specific prepaid card is typically limited to the specific point of sale systems where proprietary closed loop, network software has been installed to support the activation process. In such systems integration of proprietary software requires significant testing and integration tasks that may also need to span various POS hardware manufacturers and software systems. The result is extensive time and labor needed to implement the proprietary activation solution.

Another of the problems and issues with current stored value, prepaid products and the associated processes is that open loop activation of such cards requires software changes to support the network specific transactions proprietary to the universal payment networks. This solution also entails added cost and effort for integration and testing prior to full scale implementation across a retail POS platform.

With both open and closed loop networks residing within the United States, the Federal Reserve Bank's Automated Clearing House (ACH) and wire transfer network is used to complete electronic transfers of funds from one bank account to another. An equivalent central banking system and network is prevalent in countries worldwide and is used to complete electronic settlement in support of payments for goods and services completed using stored value, prepaid cards.

Moreover, physical card formats are manufactured with varying magnetic stripe, bar code data and, in the United States cards are moving to include chip EMV systems, all which are proprietary to the network, resulting in added cost and complexity for maintaining inventory for the various proprietary card networks. As such, retailers are hesitant to offer, sell and activate stored value cards that are not associated with the universal payment networks.

Finally, while current stored value, prepaid and other financial card products and the associated processes permit the card holder to limit their purchases to the amount that is stored, there is no ability to permit compartmentalization of those purchases and to limit spending to pre-established amounts within specific categories of items. Thus, funds that may have been earmarked for food may be employed for leisure activities and purchases, thereby bypassing one of the budgeting benefits inherent in such current stored value, prepaid products and the associated processes.

Credit card fraud costs businesses and individuals billions of dollars each year. Thus, devices and methods for reducing or hampering credit card fraud are constantly sought. Some devices and methods for combating credit card fraud have been implemented.

For example, PAYPAL® provides a method of transferring funds between individuals. This service requires that a separate account be setup with PAYPAL® before transactions can be made. This service does not work well with telephone orders.

In another example, pre-paid credit cards can be purchased and used. Indirectly, security is increased by limiting the amount of credit associated with the account number of the pre-paid credit card. However, additional overhead is associated with each card purchased or issued, and a fee is charged for each card purchased.

In another example, a three-digit “CVV security code” is often printed on the back of a credit-card. The three-digit code can be required for internet, phone or signature debit transactions which can be employed with all financial cards. However, if the credit card (or other form of financial card) itself is stolen, then this security measure provides no protection against fraud.

There is also a need to permit individuals to compartmentalize their spending and more effectively manage their finances by limiting what they are immediately able to spend, while at the same time permitting them to obtain benefits what will enhance their overall purchasing power and the value of what they are receiving. Generally, prepaid financial instruments are not capable or designed to do other than to permit a merchant to reduce the stored amount on the instrument by the amount of the purchase. There is generally no capability for a merchant to effectuate a pre-established discount or coupon and let a individual enjoy the immediate benefit of the reduced purchase price due to the discount, thus permitting the individual to retain more funds on the pre-paid financial instrument.

There is also a need to permit merchants to provide secondary offers in response to an individual redeeming a first offer or coupon and permitting the secondary offer to be associated with the financial instrument. Permitting secondary offers further builds customer loyalty to the merchant and to the first offer provider.

There is also a need to permit merchants, manufacturers, providers of financial cards and others to provide offers, incentives and alternate rewards and credits for the ultimate benefit of customer for conducting certain actions that enhance the merchant, manufacturer or financial card provider loyalty with the customer.

There is an additional need to permit the creation of a cooperative storage and distribution method and system for the providing of national as well and hyper-local offers and a consortium of offers that can be accessed by merchants to provide primary and secondary offers and other incentives in connection with a prepaid financial instrument.

There is a still further need to permit the implementation of a compartmentalized, current stored value, prepaid financial instrument and the associated processes that permits the consumer to, maintain pre-established budget limits within a prepaid financial instrument, receive rewards and incentives through merchant implemented redemption of those rewards and incentives. In addition, there is a need to permit the further loading of secondary incentives and rewards on financial cards products upon the initial redemption or to provide offers, incentives and alternate rewards and credits for the ultimate benefit of customer for conducting certain actions that enhance the merchant, manufacturer or financial card provider loyalty with the customer including social media actions.

There is yet a still further need to permit the implementation of a compartmentalized, current stored value, prepaid financial instrument and the associated processes where a third party implements the compartmentalization that permits the consumer to maintain pre-established budget limits within a prepaid financial instrument. Such a third-party implemented system should also have the benefits of permitting the consumer to receive rewards and incentives through merchant implemented redemption of those rewards and incentives and also permit the further loading of secondary incentives and rewards on stored value, prepaid products upon the initial redemption. It should also have the benefit of further loading of secondary incentives and rewards on financial cards products upon the initial redemption or to provide offers, incentives and alternate rewards and credits for the ultimate benefit of customer for conducting certain actions that enhance the merchant, manufacturer or financial card provider loyalty with the customer including social media actions and remaining within budget limits.

### BRIEF SUMMARY OF THE INVENTION

In one aspect, a method for activating and funding a stored value, prepaid card account (or other form of financial card) is provided. The method includes acquiring, with a point of sale (POS) device or other data transfer means, a first data set associated with a stored value, prepaid card, the first data set also associated with a purchase or other acquisition of the stored value, prepaid card. The method also includes acquiring, with the POS device or other data transfer means, a second data set associated with the stored value, prepaid card, the second data set also associated with activation, deactivation, funding, loading, and reloading of a stored value, prepaid card account. The method further includes transmitting at least one specific transaction trigger amount pre-defined for card activation' and the second data se from the POS device onto a payment network.

In another aspect, one or more non-transitory computer-readable storage media is/are provided. The non-transitory computer-readable storage media has computer-executable instructions embodied thereon, wherein when executed by at least one processor, the computer-executable instructions cause the at least one processor to acquire data to permit generation of a compartmentalized, current stored value, prepaid financial instrument. The system further comprises associated processors that permits the consumer to maintain pre-established budget limits within a prepaid financial instrument, receive rewards and incentives through merchant or manufacturer implemented redemption of those rewards and incentives. The system further provides computer-executable instructions within the non-transitory computer readable storage media to permit the further loading of secondary incentives and rewards on stored value, prepaid products upon the initial redemption.

The method also includes receiving the transmission at an authorization system associated with the second data set. The method further includes transmitting, from the authorization system, a transaction approval message to the POS, the transaction approval message including data relating to a funded value of the stored value, prepaid card account. The method also includes transmitting, from the authorization system, an electronic settlement message causing a debit to the prepaid financial instrument and a concomitant payment to be made to the merchant.

The method further includes transmitting, from the authorization system, an electronic message in the amount of the funded value of the stored value, prepaid card account plus the specific transaction trigger amount, the electronic message operable to debit an account of an entity with which the stored value, prepaid card may be redeemed. The method also includes settling the amount of the funded value of the stored value, prepaid card account plus the specific transaction amount with an operator of the authorization system and payment network.

The method and system further includes associated processors that permits the consumer to receive rewards and incentives associated with the prepaid financial card through merchant implemented redemption of those rewards and incentives.

The system further provides computer-executable instructions within the non-transitory computer readable storage media to permit the further loading of secondary incentives and rewards on stored value, prepaid products upon the initial redemption.

In another aspect, one or more non-transitory computer-readable storage media is/are provided. The non-transitory computer-readable storage media has computer-executable instructions embodied thereon, wherein when executed by at least one processor, the computer-executable instructions cause the at least one processor to acquire, with a point of sale (POS) device or other data transfer means, a first data set associated with a stored value, prepaid card, the first data set also associated with the stored value, prepaid card. The Computer-executable instructions also cause the at least one processor to acquire, with the POS device or other data transfer means, a second data set associated with the stored value, prepaid card, the second data set also associated with an activation, funding, loading, and reloading of a stored value, prepaid card account and the providing of reward benefits in connection with the purchase of the product or service.

The computer-executable instructions further cause the at least one processor to transmit at least one specific transaction trigger amount pre-defined for card activation and the second data set from the POS device onto a universal payment network. The computer-executable instructions also cause the at least one processor to receive the transmission at an authorization system associated with the second data set and transmit, from the authorization system, a transaction approval message to the POS, the transaction approval message including data relating to a funded value of the stored value, prepaid card account.

The computer-executable instructions further cause the at least one processor to transmit, from the authorization system, an electronic settlement message causing a payment to be made to the merchant from the stored value, prepaid card. The computer-executable instructions also cause the at least one processor to transmit, from the authorization system, an electronic message in the amount of the funded value of the stored value, prepaid card account plus the specific transaction trigger amount, the electronic message operable to debit an account of an entity with which the stored value, prepaid card may be reduced.

The computer-executable instructions further cause the at least one processor to settle an appropriate and designated amount of the funded value of the stored value, prepaid card account plus the specific transaction amount with an operator of the authorization system and the payment network. The computer-executable instructions further cause the at least one processor to settle the reward or benefit associated with the prepaid card account and credit the prepaid card with the reward.

The computer-executable instructions further cause the at least one processor, after to settling the reward or benefit associated with the prepaid card account and crediting the prepaid card with the reward, to provide secondary rewards or benefits to the prepaid card.

The features, functions, and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is a block diagram of an activation and reward processing architecture in accordance with an aspect of the invention.

FIG. 2 is a block diagram of an activation and reward processing and redemption architecture in accordance with an aspect of the invention.

FIG. 3 is a block diagram of an activation and reward processing and redemption architecture for use with multiple merchants and manufacturers in accordance with an aspect of the invention.

FIG. 4 is a flowchart and block diagram illustrating a stored value, prepaid card activation, funding and compartmentalization process and system in connection with a reward processing and redemption architecture in accordance with an aspect of the invention.

FIG. 5 is a flowchart illustrating a merchant reward reimbursement and payment system in connection with a reward processing and redemption architecture in accordance with an aspect of the invention.

FIG. 6 is a flowchart illustrating a secure transaction activation and deactivation system in connection in connection with fraud protection in a reward processing and redemption architecture in accordance with an aspect of the invention.

### DETAILED DESCRIPTION OF THE INVENTION

The described embodiments are directed to an industry need that exists for a financial card structure and activation and funding network crossing the boundaries of proprietary systems and processing platforms in global use today to provide fund compartmentalization and incentive and reward receipt and redemption in connection with a financial instrument and/or card, including a prepaid instrument.

With regard to the financial instrument and/or card described herein, it generally refers to a financial card and more specifically will be illustrated with a stored value, prepaid card issued to consumers to use as a form of payment, allowing the cardholder to buy goods and services. In physical embodiments, the stored value, prepaid card and the associated universal card account may take the form of a bankcard, a coupon card, a pharmacy card, virtual wallet, or another third party system product. The stored value, prepaid card at least partially defines a portal to the associated stored value, prepaid card account that includes, without limitation, prepaid access accounts to permit multiple depository means and multiple access means.

The systems described herein provide fully managed and fully automated delivery of commissions owed to a distributor and activator of card accounts. In embodiments, such systems incorporate certain restricted access network (RAN) features. For example, embodiments include a RAN mall configuration which is a congregation of retailers implemented via RAN technology using multiple prepaid universal cards distributed via a third party distributor. Such systems incorporate, for example, transaction trigger amounts, both fixed and variable, which are specific amounts that trigger an event within the account activation and funding system. Further, customized merchant, program network restrictions may be accomplished through filtered authorization networks. In embodiments, PAN status changes are based on predefined choices based on a trigger amount and certain processes, which are described below, are initiated after specific ISO 8583 messages are received through the universal payment network including, but not limited to, activation, loading, reloading, reversal/void deactivation, commission, commission reversal, and others.

For example, in response to an activation request message, an account is set to “Active” status and funded. The account may be the actual prepaid payment card used at the POS, ATM or the account may be a third party, proprietary account tied to the universal payment card. A reversal/void operation indication within the message cancels an activation transaction prior to settlement causing the activated account to be reset to its original, inactive, and unfunded state. A deactivation operation indication within the message cancels an activation transaction some time after settlement causing the activated account to be reset to its original, inactive state. A commissions process is indicated in the authorization messages and represents an amount owed by program owner to distributor or card activator and similarly a commissions reversal indication is related to a process of reversing payment of commission by a card distributor to program owner.

In at least some of the embodiments described herein, methods and processes are practiced by which PAN and trigger authorization amounts are entered into point of payment for delivery via universal payment network. These include, but are not limited to, a manual entry that is keyed in via number pad or keyboard, a virtual entry made via the World Wide Web or via an online computer system or a keyed entry via a mobile or other device. Such entries also include, without limitation, an entry made by swiping an encoded magnetic stripe through a magnetic stripe reader. Furthermore, such entries include, without limitation, an, entry made by an optical machine reading a bar code, for example, a machine-readable representation of data in one dimension (1D), two dimensions (2D), 3D, and holographic formats. Moreover, such entries include, without limitation, entries made via cellular and portable devices through wireless networks and sometimes referred to as mobile apps, via contactless entry, for example, NFC (near field communication), WiBree, RFID and other proprietary entry systems which wirelessly transmit PAN data, and other proprietary methods.

Some embodiments described herein involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The above examples are exemplary only, and thus are not intended to limit in any way the definition and/or meaning of the term processor.

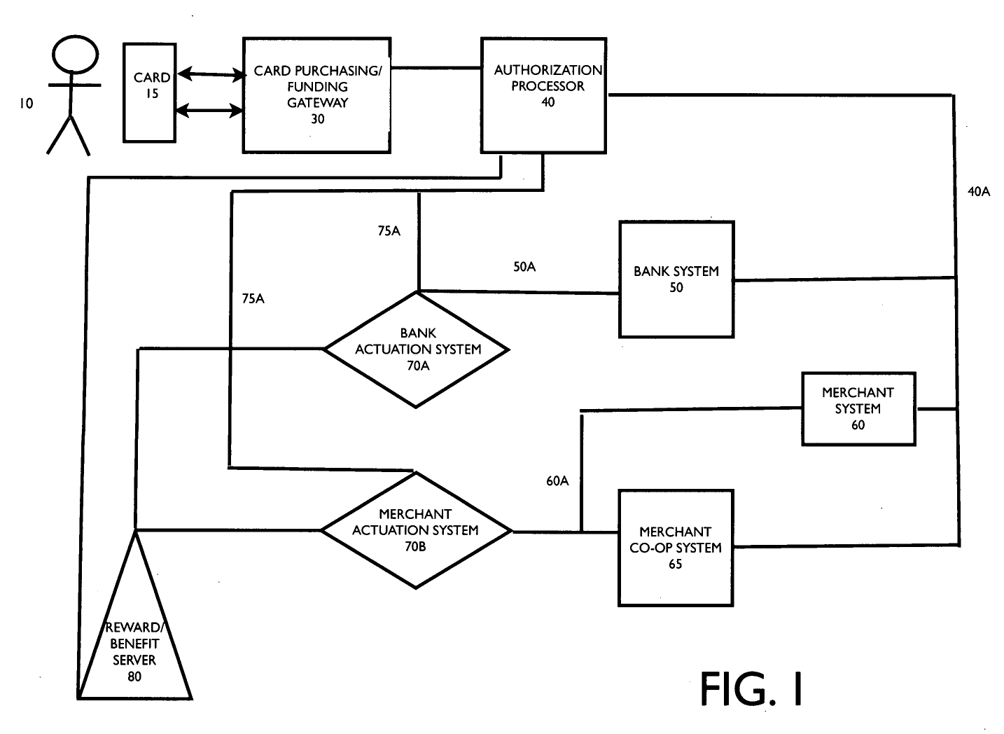

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. For clarity of explanation, the illustrative system embodiment is presented as comprising individual functional blocks (including functional blocks labeled as a “processor” or “engine”). The functions these blocks represent may be provided through the use of either shared or dedicated hardware, including, but not limited to, hardware capable of executing software. For example, the functions of one or more processors presented in FIGS. 1-5, may be provided by a single shared processor or multiple processors. Use of the term “processor” should not be construed to refer exclusively to hardware capable of executing software.

Such electronic or computing devices also typically include a memory coupled to the processor. The memory may include one or more tangible, non-transitory, computer readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory.

The methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, such as a firmware, physical and virtual storage, CD-ROMs, DVDs and another (digital source such as a network or the Internet, as well as yet to be developed digital means, with the sole exception being a transitory, propagating signal.

Conventional financial cards come in a variety of different types. Prepaid cards are one form of such cards but the description and invention relates to all financial card instruments. One popular type is similar to a conventional prepaid phone card. Such financial cards may be purchased with cash, loaded through money in a individual's account, money orders or other forms of liquid assets. These prepaid financial cards may be sold at merchants or through financial institutions who will issue them to individuals.

Certain types of prepaid financial cards are indistinguishable from conventional credit cards and may be reloadable such that additional funds can be transferred into the prepaid account to provide a balance account for the card. Although in certain instances loyalty incentives, such a point program, may be associated with a prepaid financial card, generally rewards and other benefits associated with a conventional credit card have not been associated with the prepaid card. Additionally, prepaid cards have not permitted compartmentalized spending to permit budgeting compliance in accordance with the requirement of the individual or a third party funder such as a parent or a governmental entity.

Generally prepaid financial card processing permits a consumer to purchase such a card in a predetermined amount or denomination. The consumer may acquire a card at a merchant or may have a prepaid financial card and a personal identification number obtained with the card. A merchant may activate the card at a point-of-sale terminal through the magnetic strip on the card or at some other processing center.

Alternatively, a signature debit transaction methodology may be employed to make sure that the funds are debited from a specified account. Signature debit transactions are similar to traditional credit card transactions because they are signature-authorized. But, unlike credit cards, the funds are debited from your checking account rather than charged against a line of credit. Signature-based transactions are typically accepted at retailers or service providers that honor Visa, MasterCard or Discover. A customer's authorization can be completed in one of two ways. They can sign their receipt for in-store purchases or, when making purchases online or over the phone, they can complete their purchase through a process known as a “card-not-present” transaction. This type of transactions does, not require a signed authorization.

The financial institution may provide the card at its location or at a kiosk or terminal where the consumer can enter the pin selected by him. Once the card has been activated and the amount of funding selected it may be used to purchase at most location that otherwise would accept such prepaid cards as well as many facilities that would accept other forms of financial cards and instruments.

Once the initial deposit amount or value of the card has been used, the card may be refilled with additional funds through a activation process at a merchant or financial institution or may be done at or through a mobile or computer device either in connection with the purchase or to refill the card. The card itself (not shown) may have various areas on it that carry information. One example is magnetic strip while other examples maybe holograms and chips that provide communication and data storage on the card.

Referring to FIG. 1, an individual 10, may initiate the activation and funding of a financial card 15 through a payment activation and funding network 20. In the case of a pre-paid financial card, the individual 10 may go to a merchant or to a financial institution (not shown), obtain the card 15 and commence the process through a payment activation and funding network 20. Similarly the individual may receive the card 15 by mail and activate it by the use of a PIN number provided either with the card 15 or selected by the individual 10. The individual 10 may go to a card purchasing/funding gateway 30 and either present his card 15 or ask to secure a card 15 for activation.

Upon presentation of a card 15 or request for a card, a request is submitted through the payment activation and funding network 20 via an authorization processor 40. The authorization processor 40 transmits an activation and funding request signal 40A which maybe transmitted, illustratively, to either a bank authorization system 50, a merchant system 60 or a co-op merchant system 65. It may also be provided to other activation and funding systems such as Social Security, etc. The payment funding network 20 may submit the funding request signal 40A to one or more of the above entities depending on the request by the individual 10

Thus, by way of example, a financial card 15 may have a prepayment for use through a financial institution 50 and specific use through a merchant system 60 or a co-op merchant system 65. Alternatively it may have a single prepayment specification in accordance with the desires of the individual 10. It may also have use as a financial card 15 without restriction or may be a compartmentalized card 15 that has multiple limits imposed, based upon product or merchant codes.

In the event that the card 15 has been forwarded to the individual 10 and the PIN is appropriate there is then transmitted through an authorization engine 70A and/or 70B, which are a part of the payment funding network 20, an activation response message 75A. Alternatively if the individual 10 is requesting to load or otherwise fund a prepaid card 15 and concurrent activation thereof, there is submitted an appropriate activation and funding system 20 request 40A to load the prepaid financial card 15 with the appropriate funds from an account or by cash or other means.

Once an activation response 50A, 60A or 65A is transmitted to the respective authorization engine, 70A and/or 70B, the activation response message 75A is transmitted to the authorization processor 40. The activation response message 75A may either be positive or negative, depending on whether the individual 10 has appropriate funds, is the correct individual according to the PIN, or otherwise meets the criteria for the authorization.

In the event that the activation response message 75A is in the affirmative, a reward/benefit message 80 is transmitted to a reward/benefit server 85. The reward/benefit server 85 will, advantageously, have a series of rewards and benefits 90 available to be loaded onto the prepaid card 15. The determination of what rewards and benefits 90 will be loaded may either be in accordance with selections made by the individual or may be provided by the merchants in accordance with their own determination and predisposition. The reward/benefit 90 is transmitted to the authorization processor 40 for association with the card 15.

The reward benefit server 85 may have a series of different rewards and benefits 90 which are available to the individual either by having communicated with the individual prior to the loading of the card 15 or during the authorization of the card 15. Alternatively the notification may come via, email, television or other means of communication and advertising without ever having the individual 10 enter the merchant's physical location. In another embodiment the reward benefit 90 may be learned after the individual 10 goes to merchant's facility and sees the benefit 90. In each of these instances the reward 90 may be loaded on to and associated with the card 15 and offered to the individual 10 in response for their performing the acquisitive act of purchasing the product to which the benefit is attached i.e. a discount for the product itself or some related product which is alternatively designated.

The merchant may provide the benefit directly by means of a reduction in the amount withdrawn from the prepaid financial card 15 or may provide an indication that the individual 15 has partially qualified for the reward 90 and provide a indicia of that partial qualification in order to permit the individual to subsequently satisfy the redemptive requirements. Similarly, gaming type rewards, gaming to win rewards and additional offers or offer upgrades as the individual 15 spends at merchants or elsewhere may be the rewards 90 provided.

The system should also has the benefit of permitting the consumer to receive rewards and incentives through merchant implemented redemption of those rewards and incentives and also permit the further loading of secondary incentives and rewards on stored value, prepaid products upon the initial redemption. It also has the benefit of further loading of secondary, incentives and rewards on financial card products upon the initial redemption or to provide offers, incentives and alternate rewards and credits for the ultimate benefit of customer for conducting certain actions that enhance the merchant, manufacturer or financial card provider loyalty with the customer including social media actions and/or remaining within budget limits.

The action by the customer does not have to be a redemptive action or a purchase. It can be an action such as following a merchant or manufacturer, indicating a like for them, responding to queries about products, recommending products or services etc. Furthermore, the benefit received can be in the form of additional product or service specific coupons or offers, or can be credits to an account in the form of money or other credits. Each of these can be specified by the rewarding party based upon their objectives and individual or cooperative incentive plans.

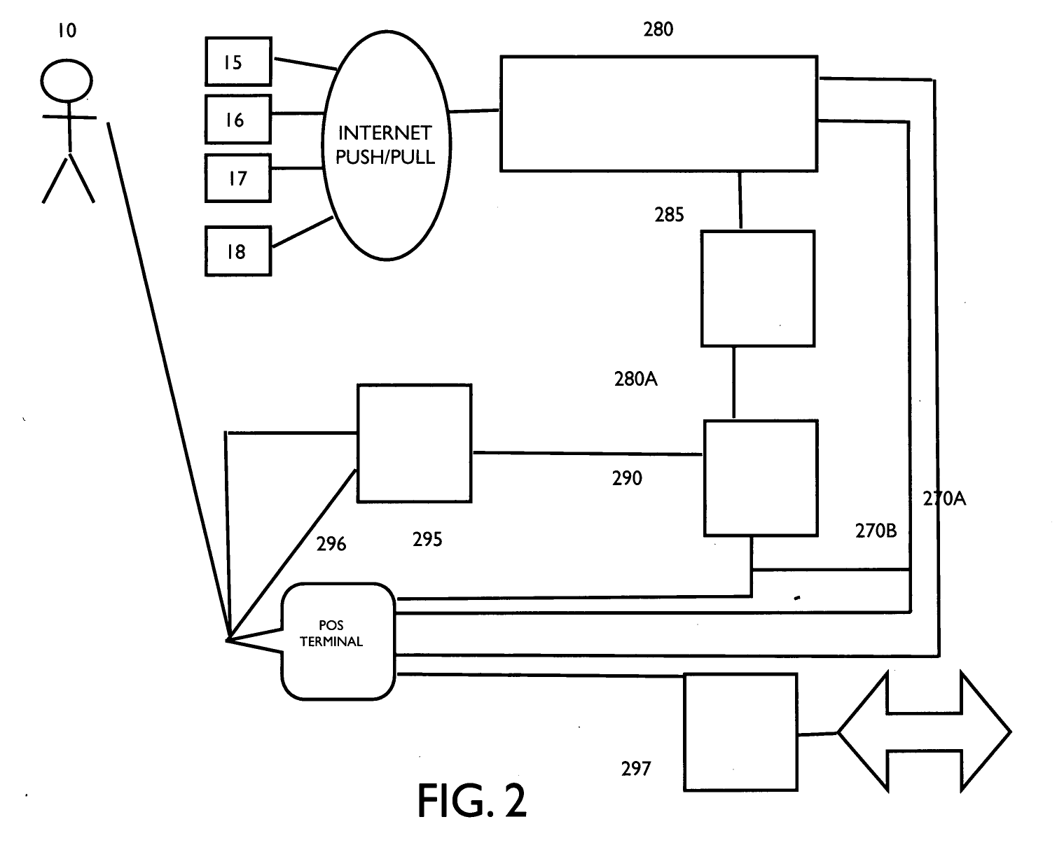

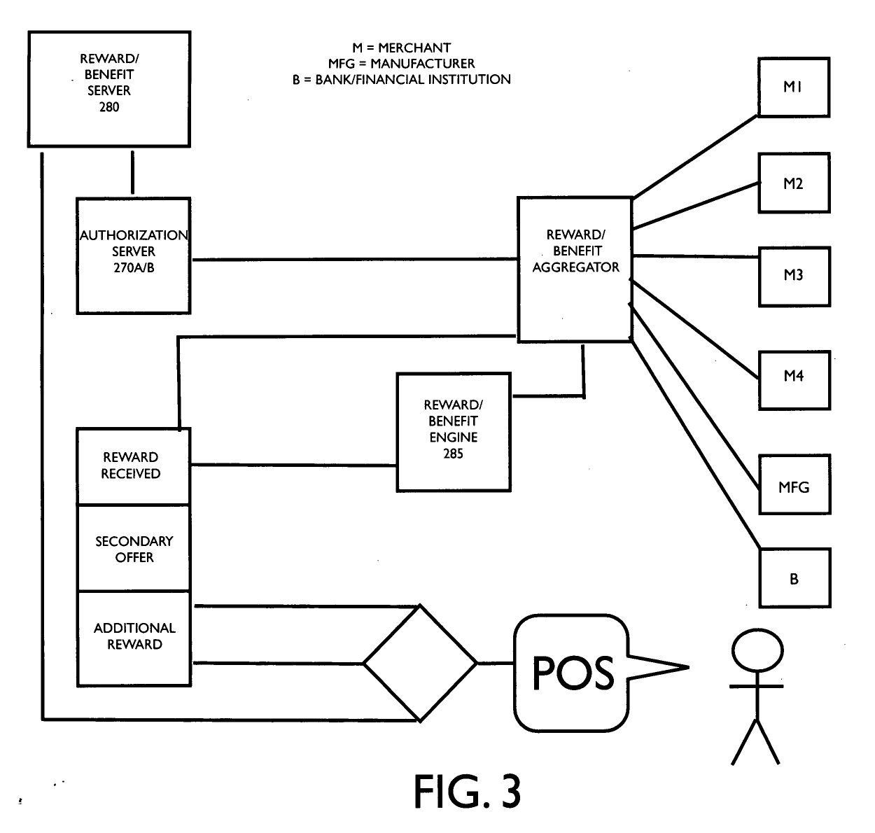

Referring to FIG. 1, FIG. 2 and FIG. 3, there is illustratively displayed several embodiments of the present invention in which a benefit/reward server 280 is populated by merchants, manufacturers and financial institutions and accessed through a benefit/reward engine 285, by the individual 10. An individual 10 may access the reward benefit server 280 through the use of his card 15, a computer network 16, a mobile device 17, or a kiosk 18. Generally the accessing of the reward benefit server 285 is in connection with a prospective purchase in order to associate the purchase with a reward/benefit 90. Alternatively a reward/benefit 90 may be displayed to the individual 10 in order to induce them to consider making the purchase in the first instance. This activity is either referred to as a “pull” when the individual 10 requests the reward whereas it is called a “push” when the merchant or financial institution initiates the dissemination of the reward/benefit 90 to the individual 10.

Once the individual 10 has determined the reward/benefit 90 which they seek in connection with the, making of a qualified purchase or other activity that is responsive to the incentive, the individual 10 may purchase the qualifying item and be awarded the reward/benefit 90. The information is provided at a point-of-sale processing terminal 296 or other location e.g. telephonic purchase, computer purchase, etc. via a computerized information network such as the Internet. By way of example, the individual may go to a merchant, present his prepaid financial instrument and/or card 15 which has associated there with a reward or benefit 90 and upon making the qualifying transaction a signal is transmitted to the rewards benefits server 280 from a point-of-sale terminal 296 or other location.

The reward/benefit server 280 transmits a authorization signal 280A to the authorization server 270A/B upon verification of the transaction. The system further verifies that the requisite sum to be paid for the transaction is associated with the prepaid card 15 (eg. that the funds are available) and that the associated reward/benefit 90 is similarly associated with the prepaid card 15. The authorization server 270A/B confirms to the point-of-sale terminal or other acquisition mode the transaction and may transmit a new load signal 290 to a load engine 295. The load engine 295 obtains a new reward/benefit 90 from the reward benefits server 280 and loads and associates that new reward to the prepaid financial instrument or card 15. Once again illustratively, the reward 90 may be a new benefit determined by the merchant in order to entice the individual 10 to make a desired purchase or maybe selected by the individual 10.

While the specific embodiments discussed above relate to the obtaining of a product and a concomitant reward/benefit 90 associated with that product, it will be appreciated that the transaction may similarly be a financial one. For example a cardholder may be asked to continue to use that particular prepaid card 15 issued by a financial institution and in response thereto the individual 10 may receive certain financial benefits such as a return of funds used. It is within the contemplation of this invention that any such benefits in connection with a qualifying transaction could be similarly loaded and associated with the prepaid card 15 in accordance with the scope of the invention and related embodiments.

It is also within the contemplation of the invention that the benefit may be monetary or a credit or other reward and may be associated with an action by the customer that is not a purchase transaction. Examples of such actions may be following a merchant or product in a social network context, recommending a product or service or taking such behavioral action as is suggested by the rewarding entity.

The reward/benefit server 280 maybe populated by merchants, manufacturers, financial institutions and others who choose to participate in the providing of such rewards/benefits 90. Thus, by way of example, after an individual 10 receives a prepaid financial card 15 with one or more rewards/benefits associated there, the individual 10 may use the card to make one or more qualifying transactions. If, by way of example, the transaction requires a certain minimum amount to be spent, then that may be spent among various merchants who are participating and the aggregate transaction requirement may be met by using the prepaid financial instrument 15 a number of times at different merchants. Thus, no individual merchant would need to fund a particular redemption financially but rather the aggregate reward/benefit 90 would ultimately be provided as a benefit associated with the prepaid financial instrument 15.

Alternatively the transaction might involve the purchasing of multiple items of different types from a particular manufacturer or manufacturers operating concert and that information would be provided such that upon the completion of the transaction it is recorded and the benefit/reward 90 obtained upon the last transaction required to fulfill the transaction requirements.

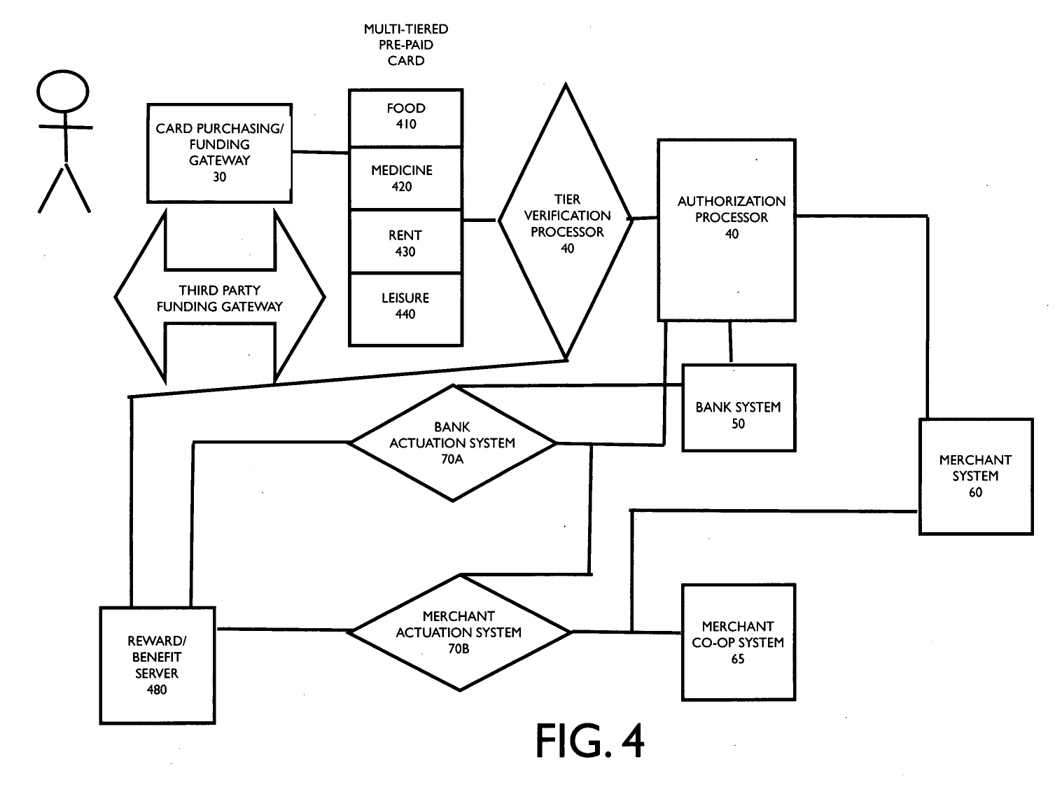

Referring to FIG. 4, in connection with FIG. 1, FIG. 2 and FIG. 3, it is yet a further aspect of the invention to permit an individual 10 or an entity that requires an individual to limit the use of certain funds to specific areas, e.g. food stamps or assistance programs, to provide a prepaid financial card 15 which has a multi-tiered budgeting structure. The prepaid financial instrument may either be individually directed to permit an individual 15 to budget for, illustratively, food 410, medicine 420, rent 430 and leisure activities 440. Alternatively, funds could be deposited upon the prepaid financial card by a governmental entity and a designation that those funds only be used for specific purposes such as food 410. Such cards would effectuate the benefit of permitting compartmentalization of spending and assist an individual 10 in maintaining a predetermined budget whether that budget is set by the individual, a third-party associated with the individual, such as a parent, or a governmental or similar entity. Alternatively, the funding of the prepaid financial instrument or card 15 could be effectuated by multiple sources (eg. roommates sharing expenses) and earmarked for separate, specific silos to restrict the use of the funds on the prepaid financial instrument or card 15.

In connection with the multi-tiered card a reward/benefit server 480 is associated in order to provide benefits both with regard to any transaction that qualifies and as a further incentive to permit the individual to remain within the multi-tiered budget. Thus, by way of example, if an individual 10 employees the prepaid financial instrument or card 15 to purchase food 410 which has associated with it a discount, or other reward, the benefit 90 would be reflected on the prepaid financial instrument and would result in an increase in, illustratively, an increase in the leisure funding 440 available on the card. Thus, by conducting the appropriate transactions, the individual 10 could select to get a reward/benefit 90 that would augment their other silos or compartments on the prepaid card 15. For example by making certain purchases of food 410 that have a discount or benefit associated with the product, an individual might be able to obtain a reduction or a discount on certain medical items 420 that would otherwise have to be purchased at full cost.

A financial institution may issue the prepaid financial cards and may print those cards along with the necessary data such as the individual and unique card number. Alternatively the cards maybe processed and obtained by an individual from a specific merchant or maybe issued by financial institution in cooperation with a particular merchant or set of merchants.

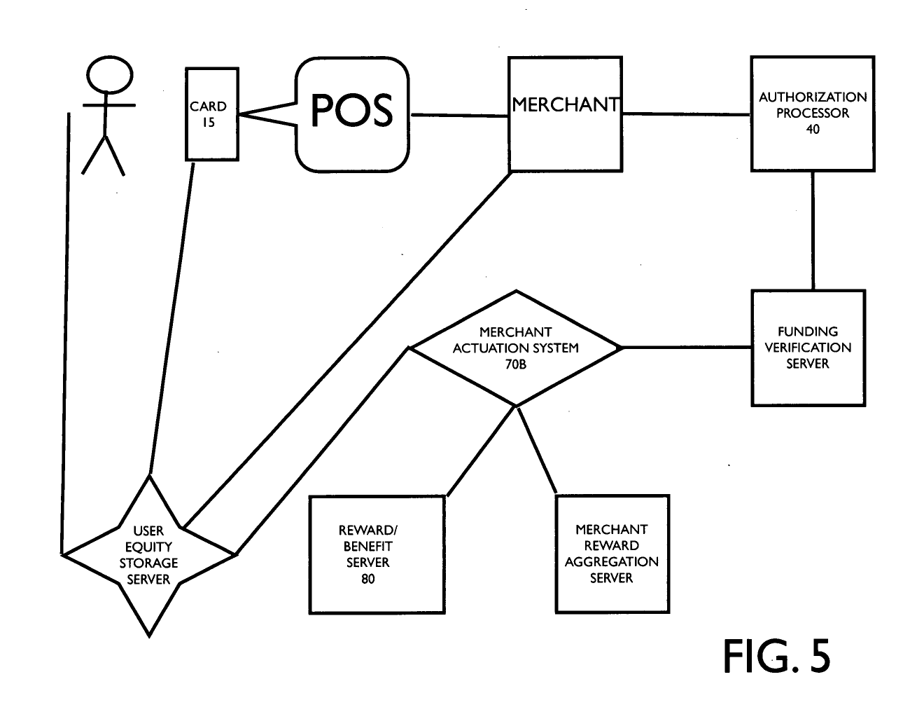

Referring to FIG. 5, in connection with FIG. 1, FIG. 2, FIG. 3 and FIG. 4, there is described an illustrative embodiment in which the reward reimbursement is accomplished by the merchant or merchants. Once a prepaid financial card is issued the consumer may use that card to purchase goods or services and obtain the benefit of the reward associated with the particular designated transaction. When the individual 10 uses the prepaid financial card 15 to purchase goods or services, the financial institution may fulfill the payment obligations to the merchant and simultaneously provide the financial benefit to the individual.

Alternatively the merchant may provide the financial benefit to the individual 10 if it is a merchant sponsored reward or a manufacturer/merchant sponsored reward. Where, as here, the prepaid financial instrument is a reusable card 15 the card may be configured such as to accept additional value in connection with one or more eligible transactions. In each instance the card 15 will be subjected to a transaction verification which will include a determination that requisite funds are available through the prepaid financial card 15 and that the transaction or transactions are qualified ones that receive a benefit. Thus, if the financial benefit is a monetary discount for the purchase of the particular product, the merchant may reduce the actual price paid by deducting a smaller amount from the prepaid card 15.

Alternatively, if the benefit is a reduction in the purchase price of a future transaction, the merchant may provide that credit to the prepaid financial card 15. As a still further embodiment the merchant may provide an additional benefit/reward 90 to further induce the individual 10 to perform a redemptive action and purchase some other product or products. In connection with each of the transactions the merchant will generally seek to obtain verification that the individual presenting the prepaid financial card 15 is qualified to do so. Such verification may take place by the use of a mobile device 17 through which the individual provides a personal identification number at the time that the transaction is taking place. This permits the financial institution or merchant to verify the identity of the individual 10.

By permitting the use of such devices in connection with the prepaid financial card 15, the benefit/reward 90 may be instantaneously obtained and credited to the prepaid financial card 15. The presently described reloadable or reusable prepaid card may be particularly useful, for example, by retail merchants, because the value of the reward provided may be low enough in each instance such that the provision of a prepaid card for each such instance may not be financially viable. However, the provision of a reloadable or reusable prepaid card may allow such retail merchants to provide lower value rewards for the purchase of its products that otherwise would not be feasible with previously known prepaid models.

As will be appreciated, this may lead to the greater availability and use of rewards at a merchant location, which may in turn drive more traffic to such merchant location. For example, a retail merchant that desires to provide a reward, which may be, for instance, in the value of one dollar or less, for a small value purchase, may likely not find it economical to provide a separate prepaid card 15 for each such purchase. However, where the retail merchant is able to simply add a value to a pre-existing prepaid card 15 with reward association means, the retail merchant may then be able to provide a reward in connection with such lesser value purchases via the card 15.

As such, these “micro-reward” or “hyper-local” benefit may be afforded greater use wherein previously such small value rewards were not economical for a retail merchant, or other merchants, to provide the customer in a standard fashion. Of course, such micro-rebates may be, and are currently, provided in an “instant rebate” format, wherein the rebate amount is immediately deducted from the purchase price at the point of sale. However, such instant rewards, particularly where they are monetary rewards, lack the verification procedures, as previously described, that are associated with rewards associated with prepaid cards 15 provided in accordance with the present disclosure. As such, presently described embodiments involving reusable prepaid cards provide the benefit of allowing retailers desirous of providing rewards of low dollar denominations, for example, micro-rewards, the ability to verify the eligibility of such rewards, in contrast to existing instant reward systems where verification is inherently limited.

Embodiments of the presently disclosed reusable prepaid cards may provide certain benefits over known methods in the art, such benefits including the flexibility of delayed or immediate use of the reward. For example, a customer who receives a reward in connection with an eligible purchase may use such reward at any time within the timeframe associated with the reusable prepaid card 15. For example, a reward eligible purchase may be made, and a rebate value or reward associated with such purchase stored on the reusable prepaid card 15, and then, at a future date, the rebate value may be used to make a purchase using the reusable prepaid card. Such future date may be substantially immediate, or it may be weeks, months, or years in the future.

Thus, by associating a particular value with a reusable card, the customer is not limited to a particular timeframe in which to use the reward, as may be typical with single use rebate cards, or single rebate checks, as is currently known in the art. Therefore, reusable prepaid cards with associated rewards provide the benefit of flexibility in connection with their use, more particularly the timeframe of their use. These benefits are also applicable to financial cards and are within the scope of this invention.

In a further benefit, embodiments of the presently disclosed reusable prepaid cards may allow a consumer to realize delayed or immediate rewards for purchasing an eligible product. Specifically, because the rewards are added to a single reusable prepaid card 15, the consumer can decide when and how to use the reward 90 or combinations of rewards 90, including how much of the combined rewards to use at any given time. In this manner, the consumer may build up “equity” on the reusable prepaid card 15 by making numerous reward-eligible purchases at various times and/or various locations, each corresponding to an individual reward value, and save such value equity for “delayed” use to make future purchases therewith. Generally the validation process which is required with a prepaid financial card necessitates that the holder of the card in fact is the individual who is permitted to use the card and furthermore that the individual has properly performed the transaction required for the reward/benefit.

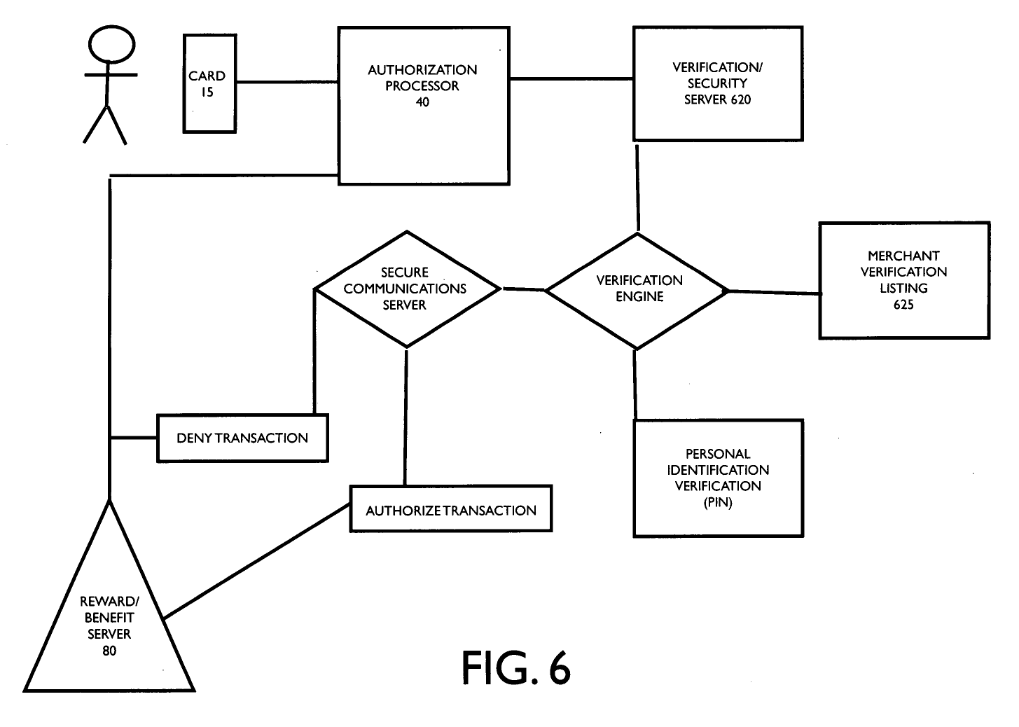

Referring to FIG. 6, there is shown a validation system which may be employed in connection with a financial card including the reusable prepaid financial card. The validation system may incorporate both a merchant specific validation as well as an individual 10 validation. Such validation systems will ensure that the card 15 is used at appropriate qualifying merchants for participating in the reward and that the individual presenting the card is both the appropriate person to have the card and is qualified to receive the reward in connection with the proposed transaction. Thus, a verification/security server 620 may have a push down listing 625 which sets forth the various merchants and institutions that are participants in a particular reward.

Similarly the verification server 620 may have personal identification information relative to the holder of the card and can verify that once the individual presenting the card provides a PIN either through the point-of-sale, a mobile device or other means. Illustratively, in the event that the merchant is not listed on the list for the particular transaction, a notification is returned and no benefit 90 is delivered to the individual 10. Similarly if the PIN or other individual identification information is not verified, the transaction can either be refused or alternatively the prepaid financial card 15 may be deactivated in order to prevent the presenting individual 10 from attempting to make further unauthorized transactions. While the identifier may be a PIN it may also be an access code, a digital certificate, a microchip, a near field identifier or other type of verification system.

Although the present disclosure has been described with reference to preferred embodiments, persons skilled in the art will recognize that changes may be made in form and detail without departing from the spirit and scope of the disclosure. For example, it is recognized that multiple embodiments of reward validation or other reward processing may be suitable for use with the system and method of the present disclosure. Furthermore, the present disclosure relates to financial cards and not just to prepaid cards, the benefits and rewards are not limited to coupons or other rewards and extend to all forms of credits and benefits and the actions that may be taken to obtain the rewards

What is claimed is:

1. A financial card benefit system comprising:
a. a financial card having a data storage component associated therewith;
b. a benefit aggregation and storage system configured to receive benefits from at least one of a plurality of benefit entities;
c. a benefit processing system capable of communicating with said benefit aggregation and storage system and configured to validate rebate information stored therein;
d. a financial card data storage system for storing at least one of a plurality of card-holders' financial and personal identification information therein and capable of being accessed by a financial entity in response to the use of the financial card;
e. a benefit receiving action requirement generated by at least one of the plurality of benefit entities and directed to at least one of the plurality of card-holders;
f. a non-transitory computer-readable storage media having computer-executable instructions embodied thereon, wherein when executed by at least one processor, the computer-executable instructions cause the at least one processor to acquire data to permit to permit the card-holder who has received and fulfilled the benefit receiving action requirement to receive the associated benefit;
g. validation processor means to validate the benefit receiving action requirement and generate the benefit; and,
h. benefit transmission means to generate, integrate and provide access by the data storage component of the financial card to the benefit information relating to the validated action and fulfill the benefit obligation upon use of the financial card by the cardholder.

2. The system of claim 1 wherein the financial card is a pre-paid card.

3. The system of claim 1 wherein the financial card is a pre-paid reloadable card.

4. The system of claim 1 wherein the financial card is a credit card.

5. The system of claim 1 wherein the financial card is a debit card.

6. The system of claim 1 wherein the benefit is added to the financial card.

7. The system of claim 1 wherein the benefit may be accessed by the financial card.

8. The system of claim 1 wherein the benefit is a financial benefit.

9. The system of claim 1 wherein the benefit receiving action requirement is the purchase of at least one item.

10. The system of claim 1 wherein the benefit receiving action requirement is an action related to social media.

11. The system of claim 10 wherein the benefit receiving action requirement is an action related to social media comprising following the benefit entity or taking such other action as is designated by the benefit entity.

12. A method for providing a benefit in connection with a financial card benefit comprising:
a. issuing a financial card having a data storage component associated therewith;
b. transmitting benefits to a benefit aggregation and storage system configured to receive benefits from at least one of a plurality of benefit entities;
c. processing the benefit and communicating the validation of the rebate information stored within the benefit aggregation and storage system;
d. storing the financial card data of at least one of a plurality of card-holders' financial and personal identification information therein and accessing said data by a financial entity in response to the use of the financial card;
e. generating a benefit receiving action requirement by at least one of the plurality of benefit entities and directing said benefit receiving action to to at least one of the plurality of card-holders;
f. executing instructions situation with a non-transitory computer-readable storage media, wherein when executed by at least one processor, the computer-executable instructions cause the at least one processor to acquire data to permit the card-holder who has received and fulfilled the benefit receiving action requirement to receive the associated benefit;
g. validating the benefit receiving action requirement and generating the benefit;
h. transmitting the benefit and generating, integrating and providing access by the data storage component of the financial card to the benefit information relating to the validated action; and,
i. fulfilling the benefit obligation upon use of the financial card by the cardholder.

13. The method of claim 12 wherein the financial card is a pre-paid card.

14. The method of claim 12 wherein the financial card is a pre-paid reloadable card.

15. The method of claim 12 wherein the financial card is a credit card.

16. The method of claim 12 wherein the financial card is a debit card.

17. The method of claim 12 including the further step of adding the benefit to the financial card.

18. The method of claim 12 including the further step of accessing the benefit by use of the financial card.

19. The method of claim 12 wherein the benefit is a financial benefit.

20. The method of claim 12 wherein the benefit receiving action requirement is the purchase of at least one item.

21. The method of claim 1 wherein the benefit receiving action requirement is an action related to social media.

22. The method of claim 21 wherein the benefit receiving action requirement is an action related to social media comprising following the benefit entity or taking such other action as is designated by the benefit entity.
